(19) United States
(12) Patent Application Publication
(10) Pub. No.: US 2017/0145846 A1
(43) Pub. Date: May 25, 2017

(54) BRUSH SEALING ARRANGEMENT FOR A TURBOMACHINE, INSTALLATION SECURING ARRANGEMENT AND TURBOMACHINE

(71) Applicant: MTU Aero Engines AG, Munich (DE)

(72) Inventors: Lothar ALBERS, Munich (DE); Georg ZOTZ, Haimhausen (DE); Stephan PROESTLER, Inning a. Ammersee (DE); Stefan BEICHL, Herrsching (DE); Hermann BECKER, Karlsfeld (DE)

(21) Appl. No.: 15/358,602

(22) Filed: Nov. 22, 2016

(30) Foreign Application Priority Data
Nov. 24, 2015 (EP) 15196072.1

(51) Int. Cl. F01D 11/00; F04D 29/32; F01D 9/02; F04D 29/08; F01D 5/02; F01D 5/12; F16J 15/3288; F04D 29/54

(52) U.S. Cl. CPC F01D 11/001; F16J 15/3288; F04D 29/324; F04D 29/541; F04D 29/083; F01D 5/02; F01D 5/12; F01D 9/02; F05D 2240/56; F05D 2300/50212; F05D 2300/171; F05D 2300/174

(57) ABSTRACT

Disclosed is a brush sealing arrangement for a turbomachine, comprising at least one stator, one rotor and one brush seal. The brush seal comprises at least one brush element and one ring for receiving the brush element. The brush sealing arrangement seals a gap between the stator and the rotor. The ring is connected to the stator by means of a press-fit. The ring comprises a first material having a first thermal expansion coefficient and at least a portion of the stator comprises for receiving the ring a second material having a second thermal expansion coefficient. Also disclosed are an installation securing arrangement comprising the brush sealing arrangement and a turbomachine.

### CROSS-REFERENCE TO RELATED APPLICATIONS

The present application claims priority under 35 U.S.C. §119 of European Patent Application No. 15196072.1, filed Nov. 24, 2015, the entire disclosure of which is expressly incorporated by reference herein.

### BACKGROUND OF THE INVENTION

1. Field of the Invention

The present invention relates to a brush sealing arrangement for a turbomachine, an installation securing arrangement, and a turbomachine.

2. Discussion of Background Information

In turbomachines there are numerous seals for sealing or reducing leakage flows, bypass flows or backflows. For example, such flows in gaps between static and moving components are at least reduced by contacting or non-contacting seals. Such seals are often used as annular seals in static components, such as, for instance, in housings or guide wheels. Examples of such seals are labyrinth seals, lip seals or brush seals. When arranging the seals, care should be taken that all the sealing components remain fixed in position during the intended use of the turbomachine and remain positioned as precisely as possible in order to actually achieve the desired sealing action. A conventional fixing of a sealing ring is carried out, for example, by means of positive-locking connections, such as, for example, hooks, pins or shoulders.

In view of the foregoing, it would be advantageous to have available a brush sealing arrangement for a turbomachine.

### SUMMARY OF THE INVENTION

The present invention provides a brush sealing arrangement for a turbomachine. The arrangement comprises at least one stator, at least one rotor and at least one brush seal. The at least one brush seal comprises at least one brush element and at least one ring for receiving the brush element. The brush sealing arrangement seals a gap between the at least one stator and the at least one rotor. The at least one ring is connected to the at least one stator by a press-fit and comprises a first material having a first thermal expansion coefficient (α₁). Further, at least a portion of the at least one stator comprises, for receiving the at least one ring, a second material having a second thermal expansion coefficient (α₂).

In one aspect of the arrangement, the at least one stator may be or may comprise an inner ring of a guide wheel or a housing portion of the turbomachine.

In another aspect, the at least one rotor may be or may comprise a rotor blade portion or a shaft or a hub of the turbomachine, which hub is connected to the shaft.

In yet another aspect, the at least one rotor may be or may comprise a rotor blade portion or a shaft or a hub of the turbomachine, which hub is connected to the shaft.

In a still further aspect of the arrangement, the press-fit may comprise a connection of the at least one ring to the at least one stator, which connection is non-positive-locking in a radial direction.

In another aspect, the at least on brush element may be fixed in the at least one ring by a clamping device.

In another aspect, the at least one ring may comprise at least one support portion for fixing the at least one brush element.

In another aspect of the arrangement, the at least one brush sealing arrangement may comprise an axial securing ring for securing the at least one ring which is connected to the at least one stator.

In another aspect, the first material may have a first thermal expansion coefficient (α₁) of greater than or equal to 10×10⁻⁶ per Kelvin in a temperature range from at least 20 degrees Celsius to 400 degrees Celsius and/or the second material may have a second thermal expansion coefficient (α₂) of less than or equal to 10×10⁻⁶ per Kelvin in a temperature range from at least 20 degrees Celsius to 90 degrees Celsius. For example, the first material may be a steel and/or the second material may be a titanium alloy.

In another aspect of the arrangement, the at least one brush seal may be arranged fixed in location and fixed in position by an axial delimitation (for example, a radial shoulder) which is arranged on the at least one stator, on the one hand, and the axial securing ring, on the other hand.

The present invention also provides a turbomachine which comprises the brush sealing arrangement as set forth above (including the various aspects thereof). For example, the turbomachine may be a compressor (e.g., a high-pressure compressor) or an aircraft engine.

As set forth above, according to the invention there is proposed a brush sealing arrangement for a turbomachine which comprises at least one stator, one rotor and one brush seal. The brush seal has at least one brush element and one ring for receiving the brush element, wherein the brush seal seals a gap between the stator and the rotor. The ring is directly or indirectly connected to the stator by means of a press-fit. The ring has a first material having a first thermal expansion coefficient. At least a portion of the stator has for receiving the ring a second material having a second thermal expansion coefficient.

The turbomachine according to the invention comprises at least one brush sealing arrangement according to the invention. The turbomachine may be a compressor, in particular a high-pressure compressor. The turbomachine may also be an aircraft engine.

Advantageous developments of the present invention are in each case the subject-matter of dependent claims and embodiments.

Exemplary embodiments according to the invention may have one or more of the features mentioned below.

The brush sealing arrangement according to the invention may be constructed for use in a high-pressure compressor, in a low-pressure compressor, in a high-pressure turbine or in a low-pressure turbine of an aircraft engine.

In some embodiments according to the invention, the turbomachine is an axial turbomachine, in particular a gas turbine, in particular an aircraft gas turbine.

In specific embodiments according to the invention, the stator is a housing or a housing portion, a guide wheel or a guide wheel portion, an inner ring of the guide wheel or another static component of the turbomachine. A static component is a non-moving, in particular a non-driven and/or a non-rotating component of the turbomachine.

The term “rotor” as used herein refers in the turbomachine to a rotating member which when used in accordance with provisions rotates about a rotation axis or pivot axis of the turbomachine.

In some embodiments according to the invention, the rotor is a shaft, a hub, an impeller or an impeller portion, a covering band or a covering band portion or another rotating component of a turbomachine. A rotating component is a component which turns.

In specific embodiments according to the invention, the brush seal is an axial or a radial shaft seal.

In some embodiments according to the invention, the ring of the brush seal is a brush element receiving device, a mount for the brush element and/or a support device for brushes of a brush seal.

The term “fit” as used herein refers to a dimensional relationship between two paired components which are subjected to tolerances. In particular, the two components have a different nominal dimension. The position and size of the tolerance extents may be different. Fits or fitting systems may be standardized, for instance, in accordance with DIN or ISO standards. Fits or fitting systems may also be non-standardized. When the fits or fitting systems are non-standardized, the tolerances or fitting indications for nominal dimensions may deviate from the values of the ISO standards. In particular, the fits or fitting systems deviate from the ISO standards when non-ISO measurement units are used, for example, when the unit of length “inch” is used in place of “meter”.

The term “press-fit” as used herein refers to an interference fit of two components, which are or become connected to each other by means of a non-positive-locking connection. The two components have a different nominal dimension. The actual dimensions have at least one overdimension so that the two components can be connected to each other without any relative movement with respect to each other. According to the invention, the ring of the brush seal is connected to the stator by means of a press-fit. Consequently, both the ring and the stator have a different nominal dimension at the faces which are connected to each other and which are in contact. The press-fit or interference fit of this connection leads to both components being or becoming connected to each other in a non-positive-locking manner in the installation state.

The thermal expansion coefficient, abbreviated to a, may be referred to as a thermal length expansion coefficient. The unit of the thermal length expansion coefficient a is [m/mK].

In specific embodiments according to the invention, the first thermal expansion coefficient is different from the second thermal expansion coefficient.

The ring of the brush seal having the first material may have a larger or smaller thermal expansion coefficient with respect to the stator having the second material. For example, a ring having a material which has a larger thermal expansion coefficient with respect to an inner ring (as a stator) may, at high operating temperatures, lead to the ring of the brush seal expanding to a greater extent than the inner ring. This may lead to the non-positive-locking connection between the inner ring and the ring leading to an increased non-positive-locking connection.

Exemplary material pairings and thermal expansion coefficients are set out in the description of the Figures.

In specific embodiments according to the invention, the stator is an inner ring of a guide wheel. The guide wheel may have adjustable or non-adjustable guide vanes. The inner ring may form the radially inner termination of the guide vanes. A brush seal having a brush element and a ring may be fitted to the inner ring, in particular in the axial direction, and be connected in a non-positive-locking manner by means of a press-fit. The brush seal may, for example, completely or partially seal a gap between the inner ring and a shaft or a hub which is connected or flanged to the shaft. A secondary flow through this gap may thereby be prevented or at least reduced. This may advantageously improve the degree of efficiency of the turbomachine.

In some embodiments according to the invention, the stator is a housing or a housing portion of the turbomachine. A brush seal having a brush element and a ring may seal a gap between the housing and, for example, a covering band of an impeller. Consequently, a secondary flow, for example, a local backflow, through this gap can be prevented or at least reduced. This may advantageously improve the degree of efficiency and/or the operating behavior of the turbomachine.

In specific embodiments according to the invention, the rotor is a rotor blade portion or a shaft of the turbomachine. A rotor blade portion may be a covering band which connects the radially outer rotor blades to each other over the periphery of the impeller. The rotor may also be a shaft, a shaft portion or a huh which is connected to the shaft. The hub may in particular be a portion of a so-called front hub which is connected at the upstream side to a first rotor stage and fixes it. The first rotor stage may be adjoined by additional rotor stages, which are fixed at the downstream side to a so-called rear hub, which can also be referred to as a hub.

In some embodiments according to the invention, the press-fit comprises a connection of the ring to the stator, which connection is non-positive-locking in a radial direction. in particular, the radially outer peripheral face of the ring, or at least a portion of this peripheral face, is connected to a peripheral face of the inner ring arranged radially at the inner side. The radially inner peripheral face of the inner ring may be a step, a shoulder, a groove or another face. The inner ring may be axially divided in order to assemble the ring and/or the entire brush seal against or on the inner ring. The ring is in particular produced in an integral manner over the periphery and not in a segmented manner over the periphery.

In some embodiments according to the invention, the press-fit of the ring with the stator is not an axially non-positive-locking connection.

In some embodiments according to the invention, the ring, or portions of the ring, do/does not have any other device, arrangement or apparatus to prevent torsion or a relative movement of the ring with respect to the inner ring. A device is, for example, a hook, a tongue and groove connection, a pin, a screw or another positive-locking connection.

In specific embodiments according to the invention, the brush seal is a contacting seal, which completely or partially seals a gap by means of a brush element.

In some embodiments according to the invention, the brush seal comprises a brush element which is fixed in the ring by means of a clamping device. For example, the brush element, by means of an additional ring, in particular a second ring which is constructed as a support ring, may be releasably or non-releasably fixed by means of a clamping.

In some embodiments according to the invention, the ring comprises a support portion for fixing the brush element. A support portion may protect the brushes of the brush element from being bent over, being redirected, becoming frayed or becoming damaged, in particular from mechanical damage.

In some embodiments according to the invention, the brush sealing arrangement comprises an axial securing ring for securing the ring which is connected to the stator. An axial securing ring may be an additional securing of the brush seal in the event of possible failure of the press-fit. Alternatively or additionally, an axial securing ring may fix the brush seal in the event of mechanical failure of the brush seal or individual components of the brush seal, for example, in the event of breakage of the ring or a clamped brush element becoming loose. An axial securing ring may, in the event of failure of the brush seal or individual components of the brush seal, protect the remaining components of the turbomachine against damage.

In specific embodiments according to the invention, the first material has a first thermal expansion coefficient α₁ greater than or equal to 10×10⁻⁶ per Kelvin in a temperature range between approximately 20 degrees Celsius and 400 degrees Celsius. For example, the first material may be a metal alloy with the main component iron, for example, steel. Steel may have a thermal expansion coefficient between 10×10⁻⁶m/(m×K) and 18×10⁻⁶ m/(m×K), wherein these values refer to a temperature range between 20 degrees Celsius and 200 degrees Celsius. Such a steel alloy is, for example, the material X5CrNiCuNb17-4-4 (material No. 1.4548). In particular, the material X5CrNiCuNb17-4-4 has a thermal expansion coefficient of approximately 11×10⁻⁶ ml(m×K).

In specific embodiments according to the invention, the second material has a second thermal expansion coefficient α₂ less than or equal to 10×10⁻⁶ per Kelvin in a temperature range between approximately 20 degrees Celsius and 400 degrees Celsius. For example, the second material may be a titanium alloy. Titanium alloys may have a thermal expansion coefficient between 7.6×10⁻⁶ m/(m×K) and 10×10⁻⁶ m/(m×K), wherein these values refer to a temperature range between 20 degrees Celsius and 200 degrees Celsius. Such a titanium alloy is, for example, the material Ti—6Al—4V (abbreviated to: Ti 6-4; titanium alloy with 6 percent by weight aluminum and 4 percent by weight vanadium). In particular, the material Ti—6Al—4V has a thermal expansion coefficient of approximately 9×10⁻⁶ m/(m×K).

In some embodiments according to the invention the first material is a steel and/or the second material is a titanium alloy.

In specific embodiments according to the invention, the stator has an axial delimitation for positioning and/or limiting the axial displaceability of the brush seal (15) on the stator, wherein the axial delimitation is an installation securing member for clear position association between the brush seal (15) and the stator.

An axial delimitation may be a radially offset shoulder. For example, an inner ring acting as a stator has an intended inner nominal diameter over an axial length for fixing the ring of the brush seal. The ring cannot he fitted further onto the inner ring over this axial length if the radial shoulder with a smaller inner diameter prevents the ring from being further pushed axially. Depending on the construction of the brush seal, this shoulder may additionally be used for clear location association or position association between the ring of the brush seal and the inner ring acting as a stator. A clear location association may permit the installation of the brush seal in only one position and location. For example, the structural space upstream and downstream of the brush seal, when viewed in an axial direction, may permit only one location. If the brush seal is rotated through 180 degrees about an axis in a radial direction, it is no longer possible, for example, in an exemplary construction, to position the axial securing member. An embodiment of such a clear position association is described in greater detail in FIG. 1. A clear location association or position association of a component with respect to an additional component may he referred to as a so-called installation securing means or as a “mistake proof feature”.

The installation securing arrangement according to the invention comprises a brush sealing arrangement, wherein the brush seal is fixed in position by means of an axial delimitation which is arranged on the stator, in particular by means of a radial shoulder, on the one hand, and the axial securing ring, on the other hand, for clear location association between the brush seal and the stator. The installation securing arrangement according to the invention further comprises a clear arrangement for fixing the brush seal in both axial directions, both in a positive and in a negative axial direction, between the axial delimitation and the axial securing ring. This arrangement may be referred to as position fixing.

Many or all of the embodiments according to the invention may have one, several or all of the advantages mentioned above and/or below.

Using the brush sealing arrangement according to the invention, the ring of the brush seal (the ring of the brush seal may be referred to as a sealing ring) may be constructed in a manner which is simple in terms of construction and production technology. As a result of the press-fit according to the invention between the ring and the stator, it is advantageously possible to dispense with additional or alternative means for preventing torsion of the sealing ring with respect to the stator. In particular, no hook or another positive-locking torsion prevention means is necessary on the sealing ring and/or the stator in order to prevent a relative movement, in particular in the intended operation-related use of the brush sealing arrangement. For example, the sealing ring may be constructed purely as a rotational component. Consequently, the production costs for the sealing ring and/or the stator can advantageously be reduced. A hook or another component is not necessary with a press-fit. Furthermore, the assembly of the brush seal on or against the stator can advantageously be carried out in a simplified manner since, for example, no precise peripheral positioning is necessary for a positive-locking connection as a torsion prevention means.

Using the installation securing arrangement according to the invention, it is advantageously possible to achieve a clear location and position fixing with respect to the installation of the brush seal. In the event of incorrect installation, that is to say, for example, when the brush seal is installed around a position rotated through 180 degrees in a radial direction, although the brush seal can initially be fitted on the stator, the axial securing ring cannot be mounted at the intended position. Consequently, the installation securing arrangement according to the invention prevents incorrect assembly of the brush seal and acts as a simple installation securing of the arrangement.

### BRIEF DESCRIPTION OF THE DRAWINGS

The present invention is explained by way of example below with reference to the appended drawings, in which:

FIG. 1 shows a brush sealing arrangement according to the invention having an inner ring and a rotor; and

FIG. 2 shows a brush sealing arrangement which does not correspond to an installation securing arrangement.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

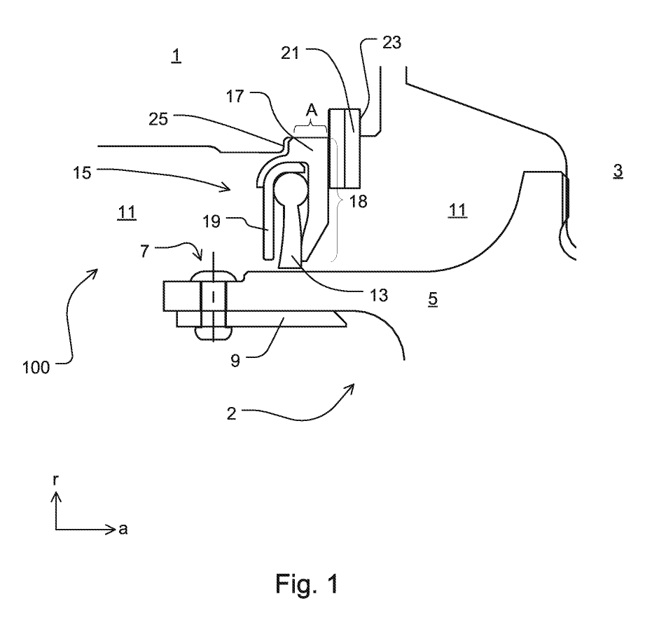

FIG. 1 shows a brush sealing arrangement 100 according to the invention with detailed cut-outs of an inner ring 1 and a rotor 2. The static inner ring 1 terminates radially at the inner side guide vanes of a guide wheel which are arranged over the periphery (not illustrated in FIG. 1). The guide wheel has the objective of redirecting the main flow in the turbomachine in order to flow against the impeller which is arranged downstream. The guide vanes may, for example, be rotatably mounted in the inner ring 1 or the arrangement may provide non-rotatable guide vanes in the inner ring 1. The rotor 2 has in FIG. 1 cut-outs of a rotor disc 3 which is connected to a hub 5. The hub 5 is connected to a shaft of the turbomachine (not illustrated in FIG. 1). Further more, the hub 5 is connected by means of a rivet 7 to a balancing weight 9.

The brush sealing arrangement 100 according to the invention seals a gap 11 (the gap 11 may be referred to as a cavity) between the static inner ring 1 and the rotatable hub 5. A brush seal 15 comprises a ring 18 and a brush element 13. The ring 18 is divided in two and has a covering ring 17 and a support ring 19. The brush element 13 is fixed by means of a clamping between the covering ring 17 and the support ring 19. Both the covering ring 17 and the support ring 19 engage around the brush element 13 in such a manner that the brushes of the brush element 13 during operation in the event of a rotation of the hub 5 cannot bend in an axial direction a or break away, either at the upstream side (on the left in FIG. 1) or at the downstream side (on the right in FIG. 1).

The covering ring 17 is according to the invention connected to the inner ring 1 by means of a press-fit in the axial portion A. A non-positive-locking press-fit may in this embodiment be implemented substantially by means of interference fits of the components (inner ring 1 and covering ring 17) and different thermal expansion coefficients, on the one hand, of the material of the inner ring 1 and, on the other hand, of the material of the covering ring 17, wherein the thermal expansion coefficients of the two materials are different from each other in this embodiment. By means of such a press-fit, a torsion of the brush seal 15, that is to say, a relative movement of the covering ring 17, and consequently of the entire brush seal 15, with respect to the inner ring 1 is prevented during the intended operation-related use (operational event). That is to say, the friction force between the covering ring 17 and the inner ring 1 is sufficiently high to prevent a relative movement between the two components. The operational event may in this instance involve all intended conditions for use with the corresponding load situations and operating temperatures. The operating temperatures may, for example, be from 200 degrees Celsius to 300 degrees Celsius or more in an aircraft engine.

Purely by way of example, the inner ring 1 may be produced from a titanium alloy having a thermal expansion coefficient between 7.6×10⁻⁶ m/(m×K) and 10×10⁻⁶ m/(m×K) or comprise such a titanium alloy, wherein these values are based on a temperature range between 20 degrees Celsius and 200 degrees Celsius. Such a titanium alloy is, for example, the material Ti—6Al—4V (titanium alloy with 6 percent by weight aluminum and 4 percent by weight vanadium).

Also purely by way of example, the covering ring 17 may be produced from a steel alloy with a thermal expansion coefficient between 10×10⁻⁶ m/(m×K) and 18×10⁻⁶ m/(m×K) or may comprise such a steel alloy, wherein these values are based on a temperature range between 20 degrees Celsius and 200 degrees Celsius. Such a steel alloy is, for example, the material X5CrNiCuNb17-4-4 (material No. 1.4548).

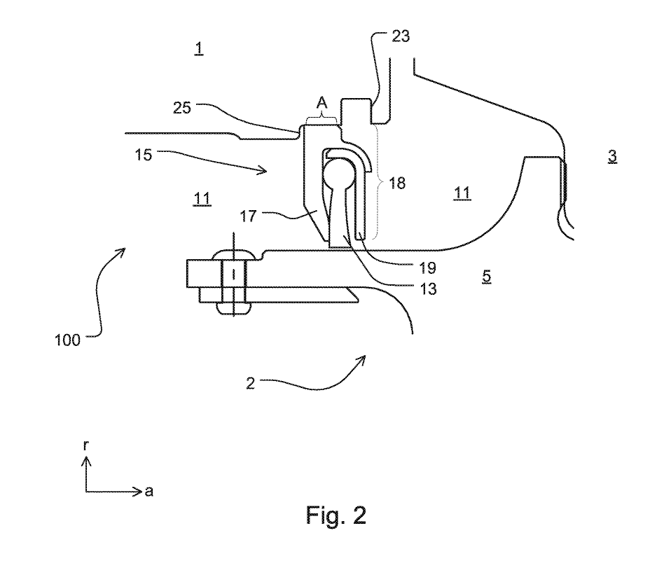

FIG. 1 further shows an axial securing ring 21 which is secured as additional securing to prevent loosening and/or axial displacement of the brush seal 15 in or on the inner ring 1. The axial securing ring 21 may be referred to as a snap ring. The axial securing ring 21 is in particular positioned by means of pretensioning in a groove 23 in the inner ring 1. The axial securing ring 21 is further a component of an installation securing means of the brush seal 15. When the brush seal 15 is incorrectly installed, the axial securing ring 21 cannot be installed and consequently acts as an installation securing means (see FIG. 2).

The outer diameter of the covering ring 17 and the inner diameter of the inner ring 1 have in particular in the axial portion A different nominal diameters. The outer diameter of the covering ring 17 and the inner diameter of the inner ring 1 may have different fitting dimensions. In the present case of the press-fit, both the covering ring 17 and the inner ring 1 have overdimensions. The overdimensions may be referred to as tolerance dimensions or tolerances. The press-fit is in particular not a standardized fit. A standardized fit is, for example, an ISO fit (ISO=international Organization for Standardization).

For simpler assembly, the brush seal 15 may be cooled with the covering ring 17, the support ring 19 and the brush element 13 in order to reduce the outer diameter of the ring 18 (or only the covering ring 17). Additionally or alternatively, the inner ring 1 may be heated. For example, the brush seal 15 may be cooled by approximately 100 degrees Celsius and/or the inner ring 1 may be heated by approximately 100 degrees Celsius. Subsequently, the brush seal 15 may be inserted in the opposite axial direction a (with respect to the coordinate system of FIG. 1) into the inner ring 1 (the axial securing ring 21 is not yet mounted). With respect to FIG. 1, the brush seal 15 is pushed to the left. After the assembly, both components can be heated or cooled again in order to bring them to the same temperature, for example, to an ambient temperature of 20 degrees Celsius. By means of a subsequent temperature compensation (heating of the brush seal 15 or cooling of the inner ring 1), a non-positive-locking press-fit is achieved in a radial direction in the axial portion A. When the temperature is increased in the operating state, for example, to 150 degrees Celsius or 200 degrees Celsius, the brush seal 15 expands to a greater extent, in particular the covering ring 17, as a result of the material with the higher thermal expansion coefficient (see above). Consequently, the non-positive-locking connection between the brush seal 15 and the inner ring 1 is also ensured at higher temperatures.

The brush seal 15, in particular the covering ring 17, can be fitted only as far as the shoulder 25 of the inner ring 1. The shoulder 25 limits the axial displacement path of the brush seal 15. As a result of the construction of the covering ring 17, however, a region of the covering ring 17 which is located radially further inside protrudes beyond the shoulder 25 (in FIG. 1 the region of the covering ring 17 which is bent to the left and which abuts the support ring 19). The support ring 19 also engages beyond the shoulder 25, in FIG. 1 counter to the axial direction a (in FIG. 1 to the left). In the installed state, the brush seal 15 is fixed by means of the axial securing ring 21 and is secured in position. This described structural embodiment of the brush seal 15, the inner ring 1 and the axial securing ring 25 enables an installation of the brush seal 15 only in the arrangement shown in FIG. 1. In an arrangement rotated through 180 degrees (about the radial axis r perpendicularly to the axial axis a) of the brush seal 15, an installation, in particular of the axial securing ring 21, would no longer be possible. This structural embodiment consequently enables a clear location association or position association of the brush seal 15 with respect to the inner ring 1. This structural embodiment is referred to as a so-called installation securing means or “mistake proof feature”. In FIG. 2, an incorrect installation which prevents the assembly of the axial securing ring 21 is shown by way of example.

FIG. 2 shows a brush sealing arrangement 100 which does not correspond to an installation securing arrangement. The brush seal 15 is rotated through 180 degrees with respect to the arrangement in FIG. 1, about an axis in the radial direction r. In this installation arrangement, the axial securing ring 21 (see FIG. 1) cannot be installed in the groove 23. Consequently, the arrangement in FIG. 2 is not an installation securing arrangement. An installation securing arrangement as illustrated in FIG. 1 ensures an intended correct location and position-orientated arrangement with respect to the installation of the brush seal 15.

### LIST OF REFERENCE NUMERALS

100 Brush sealing arrangement
a Axial; axial direction
r Radial; radial direction
u Peripheral direction
A Axial portion
1 Inner ring
2 Rotor
3 Rotor disc
5 Hub
7 Rivet
9 Balancing weight
11 Gap; cavity
13 Brush element
15 Brush seal
17 Covering ring
18 Ring
19 Support ring
21 Axial securing ring
23 Groove
25 Shoulder

What is claimed is:

1. A brush sealing arrangement for a turbomachine, wherein the arrangement comprises at least one stator, at least one rotor and at least one brush seal, the at least one brush seal comprising at least one brush element and at least one ring for receiving the brush element and the brush sealing arrangement sealing a gap between the at least one stator and the at least one rotor, and wherein the at least one ring is connected to the at least one stator by a press-fit, the at least one ring comprising a first material having a first thermal expansion coefficient (α₁) and at least a portion of the at least one stator comprising for receiving the at least one ring a second material having a second thermal expansion coefficient (α₂).

2. The brush sealing arrangement of claim 1, wherein the at least one stator is or comprises an inner ring of a guide wheel or a housing portion of the turbomachine.

3. The brush sealing arrangement of claim 1, wherein the at least one rotor is or comprises a rotor blade portion or a shaft or a hub of the turbomachine, which hub is connected to the shaft.

4. The brush sealing arrangement of claim 2, wherein the at least one rotor is or comprises a rotor blade portion or a shaft or a hub of the turbomachine, which hub is connected to the shaft.

5. The brush sealing arrangement of claim 1, wherein the press-fit comprises a connection of the at least one ring to the at least one stator, which connection is non-positive-locking in a radial direction.

6. The brush sealing arrangement of claim 1, wherein the at least on brush element is fixed in the at least one ring by a clamping device.

7. The brush sealing arrangement of claim 1, wherein the at least one ring comprises at least one support portion for fixing the at least one brush element.

8. The brush sealing arrangement of claim 1, wherein the at least one brush sealing arrangement comprises an axial securing ring for securing the at least one ring which is connected to the at least one stator.

9. The brush sealing arrangement of claim 1, wherein the first material has a first thermal expansion coefficient (α₁) of greater than or equal to 10×10⁻⁶ per Kelvin in a temperature range from at least 20 degrees Celsius to 400 degrees Celsius.

10. The brush sealing arrangement of claim 1, wherein the second material has a second thermal expansion coefficient (α₂) of less than or equal to 10×10⁻⁶ per Kelvin in a temperature range from at least 20 degrees Celsius to 90 degrees Celsius.

11. The brush sealing arrangement of claim 10, wherein the second material has a second thermal expansion coefficient (α₂) of less than or equal to 10×10⁻⁶ per Kelvin in a temperature range from at least 20 degrees Celsius to 90 degrees Celsius.

12. The brush sealing arrangement of claim 1, wherein the first thermal expansion coefficient is different from the second thermal expansion coefficient.

13. The brush sealing arrangement of claim 1, wherein the first thermal expansion coefficient is higher than the second thermal expansion coefficient.

14. The brush sealing arrangement of claim 1, wherein the first material has a first thermal expansion coefficient (α₁) of greater than 10×10⁻⁶ per Kelvin in a temperature range from at least 20 degrees Celsius to 400 degrees Celsius and the second material has a second thermal expansion coefficient (α₂) of less than 10×10⁻⁶ per Kelvin in a temperature range from at least 20 degrees Celsius to 90 degrees Celsius.

15. The brush sealing arrangement of claim 1, wherein the first material is a steel and/or the second material is a titanium alloy.

16. An installation securing arrangement comprising the brush sealing arrangement of claim 1, wherein the at least one brush seal is arranged fixed in location and fixed in position by an axial delimitation which is arranged on the at least one stator, on the one hand, and an axial securing ring, on the other hand.

17. The installation securing arrangement of claim 16, wherein the axial delimitation comprises a radial shoulder.

18. A turbomachine comprising the brush sealing arrangement of claim 1.

19. The turbomachine of claim 18, wherein the turbomachine is a compressor.

20. The turbomachine of claim 18, wherein the turbomachine is an aircraft engine.
